(19) United States
(12) Patent Application Publication
(10) Pub. No.: US 2024/0246058 A1
(43) Pub. Date: Jul. 25, 2024

(54) 13X ZEOLITE, SYNTHESIS METHOD AND USE THEREOF

(71) Applicant: HINDUSTAN PETROLEUM CORPORATION LIMITED, Devanagonthi, Bengaluru (IN)

(72) Inventors: Hemant MISHRA, Devanagonthi, Bengaluru (IN); Sanju KUMARI, Devanagonthi, Bengaluru (IN); Pramod KUMAR, Devanagonthi, Bengaluru (IN); Prashant MISHRA, Devanagonthi, Bengaluru (IN)

(21) Appl. No.: 18/262,882

(22) PCT Filed: Oct. 17, 2022
(86) PCT No.: PCT/IN2022/050924

§ 371 Date: Jul. 25, 2023

(30) Foreign Application Priority Data
Dec. 21, 2021 (IN) 202141059895

(51) Int. Cl. B01J 20/18; B01J 20/28; B01J 20/30

(52) U.S. Cl. CPC B01J 20/18; B01J 20/28011; B01J 20/3042; B01J 20/3078; B01J 20/28064

(57) ABSTRACT

The present disclosure relates to a 13X zeolite, a 13X zeolite adsorbent and a synthesis method thereof. Wherein, the synthesis method includes preparing a seed material by mixing sodium aluminate, sodium silicate, NaOH into water to get a seed mixture, stirring the seed mixture and aging. Then preparing the 13X zeolite by mixing sodium aluminate, sodium silicate, NaOH into water, followed by 0-5 wt. % addition of the seed material to obtain a gel mixture. Stirring the said gel mixture for 1 hour and crystallization of the gel mixture, then a filtration step and a washing step is performed to obtain a 13X zeolite cake. Further, the 13X zeolite cake is dried at 120° C. for 24 hours, then crushed and grinded to obtain a 13X zeolite powder. The 13X zeolite adsorbent is prepared by binding the 13X zeolite powder with a binder.

### FIELD OF THE INVENTION

The present invention relates to a 13X zeolite, synthesis method and use thereof. Specifically, the present invention relates to a 13X zeolite adsorbent used for improving nitrogen adsorption capacity during oxygen production process from air.

### BACKGROUND OF THE INVENTION

Oxygen is a colorless gas found in the air and is a most important chemical element. Further, oxygen is required by all animals and is one of the life-sustaining elements on earth. Oxygen is also used in many industrial, commercial, medical and scientific applications. Recently, during the COVID-19 outbreak many countries faced shortage of oxygen supply in their critical care units. Due to many applications, there is always huge demand for pure oxygen and separation of oxygen from air is the best known industrial process for economically producing pure Oxygen.

However, production of oxygen from air requires removal of other components like nitrogen, helium, argon and the like. The most common method for production of oxygen from air is pressure swing adsorption/vacuum pressure swing adsorption. For adsorption of nitrogen and other contaminants, an adsorbent based on 13X zeolite and LSX zeolite are used. Some of these prior known zeolites and their use in producing oxygen from air is explained hereinbelow.

WO1996002462A1 discloses a method for producing crystalline synthetic faujasite of the zeolite ‘X’ type. The method comprises (a) separately preparing a sodium silicate solution and a sodium aluminate solution, (b) admixing the sodium silicate solution and the sodium aluminate solution at high shear until a mixture results having a ratio of sodium oxide to silica of 0.4:1 to 1:1, silica to alumina of 25:1 to 1.5:1, and water to sodium oxide of 20:1 to 50:1, (c) heating said mixture to a temperature of about 80 to 120° C. in the absence of any further mixing for a period of time sufficient to produce the desired crystalline faujasite of the zeolite ‘X’ type, and (d) recovering said zeolite ‘X’.

U.S. Ser. No. 10/850,988B2 discloses a process for synthesizing zeolite X crystals comprising at least one step of adding seeding agent(s) into a synthesis gel and at least one step of forming zeolite X crystals at a temperature strictly greater than 120° C., preferably equal to or greater than 130° C.

U.S. Ser. No. 10/888,837B2 discloses the use, for gas separation, of at least one zeolite adsorbent material comprising at least one FAU zeolite, said adsorbent having an external surface area greater than m2·g⁻¹, a non-zeolite phase (PNZ) content such that 0<PNZ≤30%, and an Si/Al atomic ratio of between 1 and 2.5. The invention also concerns a zeolite adsorbent material having a Si/Al ratio such that 1≤Si/Al<2.5, a mesoporous volume of between 0.08 cm3·g⁻¹ and 0.25 cm3·g⁻¹, a (Vmicro-Vmeso)/Vmicro ratio of between 0.5 and 1.0, non-inclusive, and a non-zeolite phase (PNZ) content such that 0<PNZ≤30%.

U.S. Pat. No. 9,061,918B2 discloses a zeolite of the faujasite X type having a low silica content, more precisely a zeolite LSX having a Si/Al atomic ratio lower than or equal to 1.15, having a high crystallinity rate and whereof the crystals have a controlled particle size distribution. The present invention also relates to the method for preparing said zeolite LSX.

U.S. Pat. No. 5,487,882A discloses a method for producing crystalline synthetic faujasite of the zeolite “X” type is disclosed. The method comprises (a) separately preparing a sodium silicate solution and a sodium aluminate solution, (b) admixing the sodium silicate solution and the sodium aluminate solution at high shear until a mixture results having a ratio of sodium oxide to silica of 0.4:1 to 2:1, silica to alumina of 2.2:1 to 3.5:1, and water to sodium oxide of 20:1 to 70:1, (c) heating said mixture to a temperature of about 800 to 120° C. in the absence of any further mixing for a period of time sufficient to produce the desired crystalline faujasite of the zeolite “X” type, and (d) recovering said zeolite “X”.

US2005/0272594A1 discloses a lithium exchanged zeolite X adsorbent blend with improved performance characteristics produced by preparing a zeolite X, preparing a binder which includes highly dispersed attapulgite fibers wherein the tapped bulk density of the highly dispersed attapulgite fibers measured according to DIN/ISO 787 is more than about 550 g/ml, mixing the zeolite X with the binder to form a mixture, forming the mixture into a shaped material, ion exchanging the zeolite X at least 75% with lithium ions, and calcining the shaped material.

U.S. Ser. No. 10/137,428B2 discloses silica bound zeolite adsorbent particles which possess high volumetric gas adsorption capacity for the adsorption and/or desorption of gases. The adsorbents are highly effective as a gas source in volumetrically constrained applications. The silica-bound zeolite adsorbents possess a relatively high zeolite content simultaneously with a relatively low intra-particle pore volume as compared to the clay bound zeolite aggregates heretofore used as a gas source in volumetrically constrained environments, e.g., instant beverage carbonation processes, devices or systems.

U.S. Pat. No. 6,638,340B1 discloses an improved adsorbent useful in removing contaminants from various air streams. The adsorbent contains a zeolite, an alumina and a metal component. The metal component is present in an amount at least 10 mol-% of the stoichiometric amount of metal (expressed as the oxide) needed to balance the negative charge of the zeolite lattice. In a specific application an adsorbent comprising zeolite X, alumina and sodium is used to purify an air stream in order to remove water, carbon dioxide and other impurities including hydrocarbons.

U.S. Pat. No. 8,557,028B2 discloses binderless BaKX zeolitic adsorbents, methods for their production, and adsorptive separation using the adsorbents are provided. An adsorbent comprises a first Zeolite X having a silica to alumina molar ratio of from about 2.0 to about 3.0; a binder-converted Zeolite X wherein a ratio of the binder-converted Zeolite X to the first Zeolite X ranges from about 10:90 to about 20:80 by weight; and barium and potassium at cationic exchangeable sites within the binderless BaKX zeolitic adsorbent. Potassium ranges from about 0.9 wt % to about 1.5 wt % and barium ranges from about 30 wt % to about 34 wt % of the binderless BaKX zeolitic adsorbent.

The aforementioned references disclose various zeolites and zeolitic adsorbents. However, high nitrogen adsorption capacity and good crushing strength are essential requisite for a good adsorbent. Accordingly, there is a continuous demand for zeolitic adsorbents which show high nitrogen adsorption capacity and good crushing strength.

### Technical Advantages of the Invention

The present invention provides 13X zeolite and their synthesis method, wherein, the adsorbent prepared from the said zeolite shows high crystallinity in the range 110-120% and high surface area in the range of 750-810 m²/g.

Another advantage of the present invention is 13X zeolite adsorbent having high nitrogen adsorption capacity and crushing strength compared to commercial adsorbent.

### SUMMARY OF THE PRESENT INVENTION

The present disclosure provides a 13X zeolite and a method for synthesis of the same. The method includes firstly preparing a seed material and then preparing the 13X zeolite. Wherein, the seed material is prepared by mixing sodium aluminate, sodium silicate, NaOH into water to get a seed mixture, stirring the seed mixture for 1-1.5 hour and aging at 30-45° C. for 18-26 hours. Then preparing the 13X zeolite by mixing sodium aluminate, sodium silicate, NaOH into water, followed by addition of the seed material to obtain a gel mixture. Then stirring the gel mixture for 50-70 minutes and crystallization of the gel mixture at 95-100° C. for 8-12 hours, thereafter, a filtration step and a washing step is performed to obtain a 13X zeolite cake. The washing step is performed with hot demineralized water of temperature 90° C. Washing step is repeated two to three times for removal of occluded sodium.

The seed material is prepared by mixing sodium aluminate, sodium silicate, NaOH, and water to get a seed mixture having a molar composition of 10-20SiO₂:Al₂O₃:10-20Na₂O:200-300H₂O.

Specifically, the seed material is prepared by mixing sodium aluminate, sodium silicate, NaOH, and water to get the seed mixture having molar composition of 12-15SiO₂:Al₂O₃:13-16Na₂O:250-300H₂O.

The amount of seed material added in the said gel mixture is 0-5 wt. % of gel mixture. Specifically, the amount of seed material added in the gel mixture is 0-2 wt. % of gel mixture.

Further, the 13X zeolite is prepared by mixing sodium aluminate, sodium silicate, NaOH, and water to get a gel mixture having a molar composition of 2-7SiO₂:Al₂O₃:2-7Na₂O:200-300H₂O.

Specifically, the 13X zeolite is prepared by mixing sodium aluminate, sodium silicate, NaOH, and water to get the gel mixture having molar composition of 2-4SiO₂:Al₂O₃:3-5Na₂O:250-300H₂O.

Further, the 13X zeolite cake is dried at 120° C. for 24 hours, then crushed and grinded to obtain a 13X zeolite powder.

Further, the present invention also discloses a method for preparing a 13X zeolite adsorbent by binding the 13X zeolite powder as obtained hereinabove with a binder. Preparing the extrudes or beads of the 13X zeolite adsorbent, and then drying the said extrudes or beads at 120° C. The said 13X zeolite adsorbent has high nitrogen adsorption capacity and crushing strength.

Specifically, the 13X zeolite powder is 95-98 wt. % and the binder is 2-5 wt. % and wherein, the binder is selected from a clay, an organic polymer such as a polyvinyl alcohol. The obtained 13X zeolite adsorbent has crystallinity in the range of 110-120% and surface area in the range of 750-810 m²/g respectively.

### Objectives of the Present Invention

It is the primary objective of the present invention to provide 13X zeolite and synthesis method and use thereof in oxygen production from air.

It is another objective of the present invention to provide a seed assisted synthesis method for synthesis of 13X zeolite.

Further, the 13X zeolite adsorbent synthesized by seed assisted method has high crystallinity in the range 110-120% and high surface area in the range of 750-810 m²/g.

It is another objective of the present invention to provide a 13X zeolite adsorbent having high nitrogen adsorption capacity and crushing strength compared to the commercially available 13X zeolite adsorbent.

### BRIEF DESCRIPTION OF THE DRAWING

To further clarify advantages and aspects of the present disclosure, a more particular description of the present 13X zeolite as disclosed herein will be rendered by reference to specific embodiments thereof, which is illustrated in the appended drawing(s). It is appreciated that the drawing(s) of the present disclosure depicts only typical embodiments and are therefore not to be considered limiting of its scope.

FIG. 1: illustrates a Nitrogen adsorption isotherm of the commercial zeolite adsorbent, 13X zeolite adsorbent as prepared in example 3 and example 4.

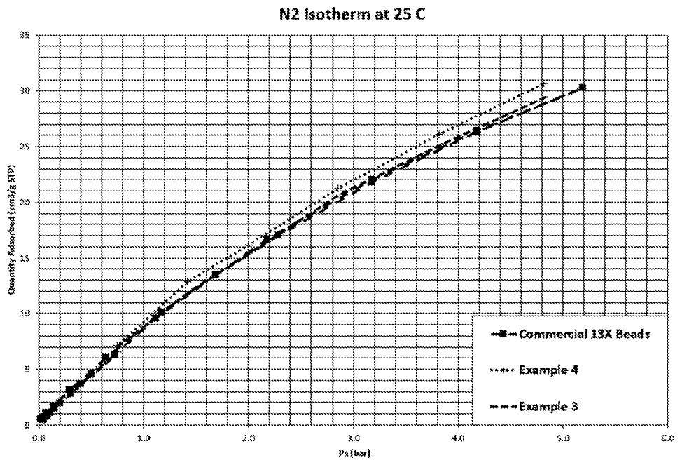

### DESCRIPTION OF THE INVENTION

According to the main embodiment, the present invention provides a 13X zeolite, synthesis method thereof, and use of 13X zeolite adsorbent in oxygen production from air. The synthesis method of said 13X zeolite includes firstly preparing a seed material and then preparing the 13X zeolite. The addition of seed accelerates crystallization and enhances surface area and crystallinity of 13X zeolite.

Specifically, the present invention provides a seed assisted method for synthesis of 13X zeolite. Wherein, the seed content is 0-2 wt. % based on gel amount and the crystallization time as required is approximately 10 hours.

The 13X zeolite adsorbent synthesized by seed assisted method has high crystallinity in the range of 110-120% and high surface area in the range of 750-810 m²/g.

### Preparation of Seed Material

Sodium aluminate, sodium silicate, NaOH and water are added to get a seed mixture having a molar composition of 10-20SiO₂:Al₂O₃:10-20Na₂O:200-300H₂O, stirring the seed mixture for 1-1.5 hour and aging at 30-45° C. for 18-26 hours.

Preferably, the seed material is prepared by mixing sodium aluminate, sodium silicate, NaOH, water to get the seed mixture having the molar composition of 12-15SiO₂:Al₂O₃:13-16Na₂O:250-300H₂O. Then stirring the said seed mixture for 1 hour and aging at 35-45° C. for 18-24 hours.

### Preparation of 13X Zeolite

Sodium aluminate, sodium silicate, NaOH and water are added to get a gel mixture having molar composition of 2-7SiO₂:Al₂O₃:2-7Na₂O:200-300H₂O, followed by 0-5 wt. % addition of seed material as prepared in first step. Then stirring the gel mixture for 50-70 minutes and crystallization of the gel mixture at 95-100° C. for 8-12 hours.

Preferably, the 13X zeolite is prepared by mixing sodium aluminate, sodium silicate, NaOH, water to get the gel mixture having molar composition of 2-4SiO₂:Al₂O₃:3-5Na₂O:250-300H₂O, followed by 0-2 wt. % addition of seed material as prepared in first step. Then stirring the gel mixture for 1 hour, followed by crystallization of gel mixture at 95-100° C. for 10 hours.

After crystallization, filtration and washing steps are carried out and obtained 13X zeolite cake is dried at 110-120° C. for 24 hours. The washing step is performed with hot demineralized water of temperature 90° C. Washing step is repeated two to three times for removal of occluded sodium.

Further, the present disclosure provides a 13X zeolite powder, wherein, the 13X zeolite cake after drying is crushed and grinded to obtain the 13X zeolite powder.

### Preparation of 13X Zeolite Adsorbent

13X zeolite adsorbent is prepared by binding the 13X zeolite powder as obtained hereinabove with a binder. Preparing the extrudes or beads of the 13X zeolite adsorbent, and then drying the said extrudes or beads at 120° C. The said 13X zeolite adsorbent has high nitrogen adsorption capacity and crushing strength.

Specifically, the 13X zeolite powder is 95-98 weight % and the binder is 2-5 weight % and wherein, the binder is selected from a clay, an organic polymer such as a polyvinyl alcohol.

Further, the present disclosure provides a 13X zeolite adsorbent and a synthesis method thereof. Wherein, the said 13X zeolite adsorbent shows high nitrogen adsorption capacity and high crushing strength compared to commercial adsorbent.

### Example 1

97 g of sodium aluminate, 194 g of sodium silicate, 62.5 g of NaOH and 1600 g of water are added to prepare an aluminosilicate gel mixture having molar composition of 3SiO₂:Al₂O₃:4.5Na₂O:298H₂O, Then stirring the gel mixture for 1 hour, followed by crystallization of gel mixture at 95° C. for 10 hours.

After crystallization, filtration and washing steps are carried out and obtained 13X zeolite cake is dried at 120° C. for 24 hours. The washing step is performed with hot demineralized water of temperature 90° C. Washing step is repeated two to three times for removal of occluded sodium.

### Example 2

For seed preparation, 11.5 g of sodium aluminate, 110 g of sodium silicate, 26.3 g of NaOH and 160 g of water are added to get a seed mixture having the molar composition of 14SiO₂:Al₂O₃:15Na₂O:287H₂O, which is referred as seed mixture, stirring the said seed mixture for 1 hour and aging at 35° C. for 24 hours. 97 g of Sodium aluminate, 194 g of sodium silicate, 62.5 g of NaOH and 1600 g of water are added to prepare an aluminosilicate gel mixture having molar composition of 3SiO₂:Al₂O₃:4.5Na₂O:298H₂O. Then stirring the gel mixture for 1 hour, followed by addition of 40 g of seed prepared as mentioned above, followed by crystallization of gel mixture at 95° C. for hours.

After crystallization, filtration and washing steps are carried out and obtained 13X zeolite cake is dried at 120° C. for 24 hours. The washing step is performed with hot demineralized water of temperature 90° C. Washing step is repeated two to three times for removal of occluded sodium.

### Example 3

13X zeolite adsorbent is prepared by binding the 13X zeolite powder prepared in example 1 with polyvinyl alcohol binder. Extrudes are prepared by mixing 9.8 g of 13X zeolite (dry basis) prepared in Example 1 and 0.2 g of polyvinyl alcohol, and then the said extrudes are dried at 120° C.

### Example 4

13X zeolite adsorbent is prepared by binding the 13X zeolite powder prepared in example 2 with polyvinyl alcohol binder. Extrudes are prepared by mixing 9.8 g of 13X zeolite (dry basis) prepared in Example 2 and 0.2 g of polyvinyl alcohol, and then the said extrudes are dried at 120° C.

### Experiments & Results

Below table 1 provides the physicochemical properties of commercial adsorbent and the 13X zeolite adsorbents as prepared in example 3 and example 4. From the table 1 it is clear that the 13X zeolite as prepared in example 4 (i.e., through seed addition) has higher crystallinity percentage and has higher microporous surface area.

TABLE 1
Physicochemical properties of synthesized 13X zeolite adsorbents

| | Seed | Relative | | External | Microporous |
|---|---|---|---|---|---|
| | content | crystallinity | MBET | SA | surface area |
| Sample | (wt. %) | (%) | (m²/g) | (m²/g) | (m²/g) |
| Commercial | — | 100 | 769.29 | 39.07 | 730.2 |
| Example-3 | 0 | 117 | 766.78 | 25.16 | 741.6 |
| Example-4 | 2 | 128 | 807.4 | 25.9 | 781.6 |

The commercial 13X zeolite based adsorbent is procured from BASF (HYDB100D Molecular sieve 13X).

Below table 2 illustrates the crushing strength and nitrogen adsorption capacity of the 13X zeolite-based adsorbents as prepared in example 3 and example 4 and the commercial used zeolite adsorbents. From the table 2 it is clear that the 13X zeolite adsorbent as prepared in example 4 (i.e., through seed addition) has improved crushing strength and has higher nitrogen adsorption capacity.

TABLE 2
Nitrogen adsorption capacity of 13X zeolite-based adsorbents

| | | | | | Nitrogen |
|---|---|---|---|---|---|
| | | | | | adsorption |
| | | Binder | | Crushing | capacity |
| | | content | 13X | strength | (cc/gm) |
| Sample | Binder | (wt. %) | zeolite | (N) | (at 4.8 bar) |
| Example-3 | Polyvinyl | 2 | Example 1 | 19 | 29 |
| | alcohol | | | | |
| Example-4 | Polyvinyl | 2 | Example 2 | 18 | 30.6 |
| | alcohol | | | | |
| Commercial | — | — | | 15 | 29 |

1. A method for synthesis of a 13X zeolite, wherein, the method comprising steps of: preparing a seed material, wherein, the seed material is prepared by mixing sodium aluminate, sodium silicate, and NaOH into water to get a seed mixture, having a molar composition of 10-20 SiO₂: Al₂O₃: 10-20 Na₂O: 200-300 H₂O, stirring the seed mixture for 1-1.5 hour and aging at 30-45° C. for 18-26 hours; and preparing the 13X zeolite by mixing sodium aluminate, sodium silicate, NaOH into water, followed by addition of the seed material to obtain a gel mixture having a molar composition of 2-7 SiO₂:Al₂O₃:2-7 Na₂O: 200-300H₂O, stirring the gel mixture for 50-70 minutes and crystallization of the gel mixture at 95-100° C. for 8-12 hours, a filtration step and a washing step with hot demineralized water is performed to obtain a 13X zeolite cake.

2. The method as claimed in claim 1, wherein the amount of seed material added in the gel mixture is 0-5 wt. % of the gel mixture.

3. The method as claimed in claim 2, wherein the amount of seed material added in the gel mixture is 0-2 wt. % of gel mixture.

4. The method as claimed in claim 1, wherein, the seed material is prepared by mixing sodium aluminate, sodium silicate, NaOH, and water to get the seed mixture having a molar composition of SiO₂: Al₂O₃: 13-16 Na₂O:250-300 H₂O.

5. The method as claimed in claim 61, wherein, the 13X zeolite is prepared by mixing sodium aluminate, sodium silicate, NaOH, and water to get the gel mixture having a molar composition of 2-4 SiO₂: Al₂O₃: 3-5 Na₂O:250-300 H₂O.

6. The method as claimed in claim 1, wherein, the 13X zeolite cake is dried at 120° C. for 24 hours, then crushed and grinded to obtain a 13X zeolite powder.

7. A method for preparing a 13X zeolite adsorbent by binding the 13X zeolite powder as claimed in claim 6 with a binder, preparing extrudes or beads of the 13X zeolite adsorbent, and then drying the said extrudes or beads at 120° C.

8. The method as claimed in claim 7, wherein, the binder is selected from a clay, an organic polymer.

9. The method as claimed in claim 8, wherein, the organic polymer is a polyvinyl alcohol.

10. The method as claimed in claim 7, wherein, the 13X zeolite powder is 95-98 weight % and the binder is 2-5 weight %.

11. The 13X zeolite adsorbent as claimed in claim 7, wherein, the said 13X zeolite adsorbent has crystallinity in the range of 110-120%.

12. The 13X zeolite adsorbent as claimed in claim 7, wherein, the said 13X zeolite adsorbent has surface area in the range of 750-810 m²/g.
